(19) United States
(12) Patent Application Publication
(10) Pub. No.: US 2017/0024676 A1
(43) Pub. Date: Jan. 26, 2017

(54) SYSTEM FOR ANALYZING AND PREDICTING CASH-AT-RISK INVESTMENTS AND GAMBLING OUTCOMES

(71) Applicant: TUCKER GUY HARRIS, COLLEGE STATION, TX (US)

(72) Inventor: TUCKER GUY HARRIS, COLLEGE STATION, TX (US)

(73) Assignee: CAPPER NETWORK, LLC, COLLEGE STATION, TX (US)

(21) Appl. No.: 15/302,580

(22) PCT Filed: Apr. 7, 2015
(86) PCT No.: PCT/US15/24797

§ 371 Date: Oct. 7, 2016

Related U.S. Application Data
(60) Provisional application No. 61/976,170, filed on Apr. 7, 2014.

(51) Int. Cl. G06Q 10/06; G06Q 40/06

(52) U.S. Cl. CPC G06Q 10/06393; G06Q 40/06; G06Q 10/06375

(57) ABSTRACT

A system is described for compiling and comparing the prediction accuracy of analysts to improve user prediction performance. The system includes a processor having software programmed to compile prediction data of the analysts based upon an outcome of the analyst's selections. The processor is in communication with a database for data storage. An interface is configured to provide an interactive link between the user and the prediction data. The interface provides a display portal for viewing the prediction data. The processor automatically tracks and records the performance history of the analysts and ranks them according to performance history. The processor presents the ranks of the analysts to the user through the display portal to the user who is then able to purchase a prediction from any of the analysts for a future event by payment of a fee.

### TECHNICAL FIELD

The present application relates generally to electronic systems predicting investment and sports outcomes, more particularly, to a system that monitors analyst performance and improves the collaboration of a participant and an analyst.

### DESCRIPTION OF THE PRIOR ART

Currently, investment (financial) and sports investment predictions are limited in how information and advice or predictions are made available to individual users. For example, currently sport investors use sports forums to converse with other sports investors when making important cash-at-risk gambling/gamin decisions. These forums can include unlimited numbers of opinions and participants making it very difficult to use in terms of finding quality sport analysts. No ranking system exists to find and sort through the types of advice available within each forum. It becomes extremely difficult to ascertain credibility. Additionally, the process is time consuming because users are typically in charge of tracking their own record manually.

Furthermore, individual participants collectively have to monitor the performance of each individual analyst and their respective opinion. There is no organized way to collectively monitor the performance of each analyst over time and with respect to particular teams, predictions, or advice.

Typically the advice given on such forums are limited. Presently, those giving advice do so voluntarily without compensation. This fails to encourage up to date and accurate information from being provided to the public if no compensation is given to those who provide insights.

A system is needed to improve upon the flaw and shortcomings of the present forums and processes that ultimately encourage disclosure of information to participants, accurate monitoring of analysts performances, and permit greater interaction between analysts and participants.

Although great strides have been made, considerable shortcomings remain.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a schematic of a system for analyzing and predicting cash-at-risk investments and gambling outcomes according to the preferred embodiment of the present application;

FIG. 2 is an exemplary schematic of the system of FIG. 1;

FIG. 3 is a chart of a series of features that may be displayed through a display portal associated with system of FIG. 1;

FIG. 4 is a more detailed chart of profile pages within the features of FIG. 3;

FIG. 5 is a chart of a series of processes or steps executed by the software and processor of the system of FIG. 1 in order to formulate a single prediction from within a grouping.

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms, such as above and below, to describe a spatial relationship between various components or to describe the spatial orientation of aspects of such components should be understood to describe a relative relationship between the components or a spatial orientation of aspects of such components, respectively, as the device described herein may be oriented in any desired direction.

The system in accordance with the present application overcomes one or more of the above-discussed problems commonly associated with conventional cash-at-risk investment outcome predictions. Specifically, the system of the present application improves on the flaws of the present systems by allowing analysts, investors, brokers, and sports/gaming users alike to be paid for their research and predictions to a level based on their internet notoriety and successful predictions. The system also allows analysts to get hired onto and/or be the creator of teams of analysts that act to produce a collective prediction according to predefined user prediction criteria. Analysts and researchers are easily ranked according to their successes within the system. These and other unique features of the system are discussed below and illustrated in the accompanying drawings.

The system will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The system of the present application is programmed to compile and determine predictions of performance related to any one of sports competitions/matchups, fantasy league performances, investment performances, and so forth. The predictions are compiled from one or more of analysts or individuals that have sufficiently proven a successful track record. The system of the present application also permits for the generation of predictions based on a collective combination of a plurality of analysts grouped into a team or group concept by a user. A grouping refers to a collection of analysts made by a user in order to produce a single prediction based off the collective selection of each analyst in the grouping. In general, a singular prediction is made based upon the individual predictions of the analyst team members. The prediction of the team may be influenced selectively by the user based upon certain criteria applied to the team as a whole or applied to selected analysts' predictions. Although it is understood that predictions may apply to sports betting, fantasy sports, and so forth; the system of the present application also applies in other areas such as investments, stock market predictions of performance, and so forth where experts/brokers/financial analysts opinions are used to select a particular investment. For purposes in this application, the system will be illustrated with respect to the sports industry.

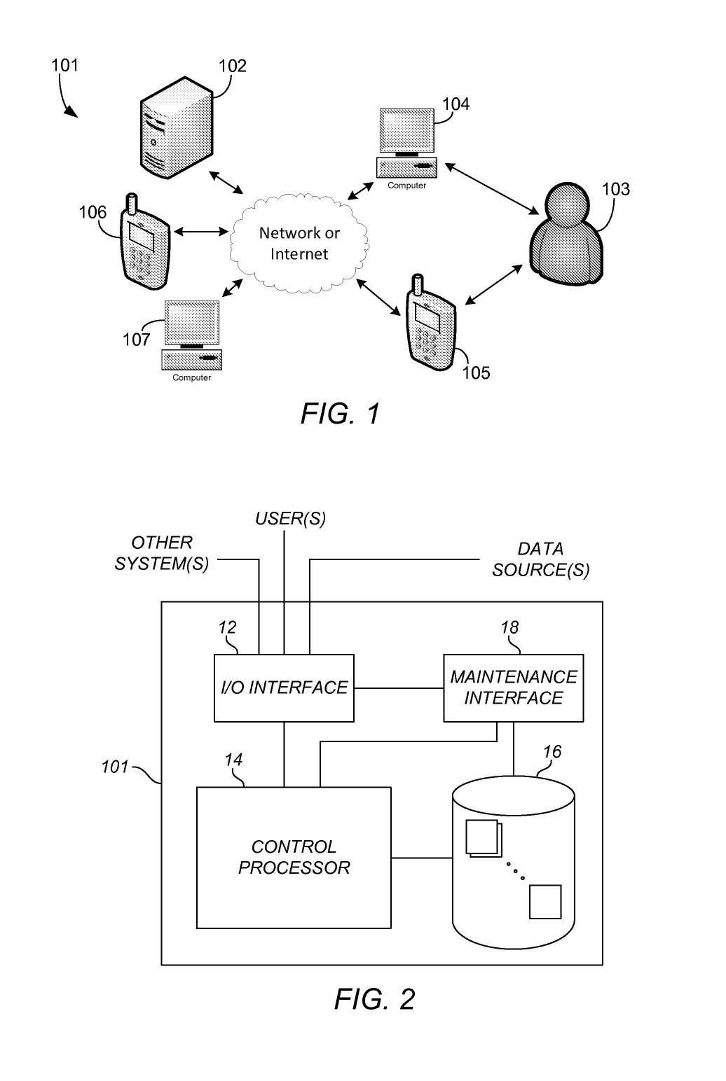

Referring now to FIG. 1 in the drawings, system 101 is illustrated. System 101 is a computerized device configured to communicate with and transfer data between one or more other electronic devices over a network such as the internet. A user 103 is able to interact and engage system 101 via one or more electronic devices, such as a computer 104 and a handheld electronic device 105 (i.e. smart phone, tablet, and so forth). System 101 compiles data from one or more independent sources through additional electronic devices 106, 107. Information from one or more users are processed by system 101 on a server 102. Information obtained from one or more outside sources is also processed by system 101. Such outside sources may be statistics and real time data from market conditions, sports betting conditions and so forth.

Referring now also to FIG. 2 in the drawings, an exemplary system 101 for compiling information from one or more sources and users to determine a performance prediction is illustrated. Individual analysts are ranked and their information/picks/predictions are viewable to the user upon the payment of a fee. A user may formulate a team prediction from the collective combination of a plurality of analysts in order to generate a singular prediction outcome. The predictions are used by the user for predicting the outcome of the sports event and player performance for example.

The system 101 includes an input/output (I/O) interface 12, a control processor 14, a database 16, and a maintenance interface 18. Alternative embodiments can combine or distribute the input/output (I/O) interface 12, control processor 14, database 16, and maintenance interface 18 as desired. Embodiments of the system 101 can include one or more computers that include one or more processors and memories configured for performing tasks described herein below. This can include, for example, a computer having a central processing unit (CPU) and non-volatile memory that stores software instructions for instructing the CPU to perform at least some of the tasks described herein. This can also include, for example, two or more computers that are in communication via a computer network, where one or more of the computers includes a CPU and non-volatile memory, and one or more of the computer's non-volatile memory stores software instructions for instructing any of the CPU(s) to perform any of the tasks described herein. Thus, while the exemplary embodiment is described in terms of a discrete machine, it should be appreciated that this description is non-limiting, and that the present description applies equally to numerous other arrangements involving one or more machines performing tasks distributed in any way among the one or more machines. It should also be appreciated that such machines need not be dedicated to performing tasks described herein, but instead can be multi-purpose machines, for example computer workstations, that are suitable for also performing other tasks. Furthermore the computers may use transitory and non-transitory forms of computer-readable media. Non-transitory computer-readable media is to be interpreted to comprise all computer-readable media, with the sole exception of being a transitory, propagating signal.

The I/O interface 12 provides a communication link between external users, systems, and data sources and components of the system 101. The I/O interface 12 is in communication with the control processor 14 and database 16 and is configured to provide an interactive link between the user and the prediction data. The I/O interface 12 can be configured for allowing one or more users to input information to the system 101 via any known input device (for example computer 104 and device 105). Examples can include a keyboard, mouse, touch screen, microphone, and/or any other desired input device. The I/O interface 12 provides a display portal defining a plurality of visually perceptible elements corresponding to the prediction data. The I/O interface 12 can be configured for allowing one or more users to receive information output from the system 101 via any known output device. Examples can include a display monitor, a printer, a speaker, and/or any other desired output device. The I/O interface 12 can be configured for allowing other systems to communicate with the system 101. For example, the I/O interface 12 can allow one or more remote computer(s) to access information, input information, and/or remotely instruct the system 101 to perform one or more of the tasks described herein. The I/O interface 12 can be configured for allowing communication with one or more remote data sources. For example, the I/O interface 12 can allow one or more remote data source(s) to access information, input information, and/or remotely instruct the system 101 to perform one or more of the tasks described herein.

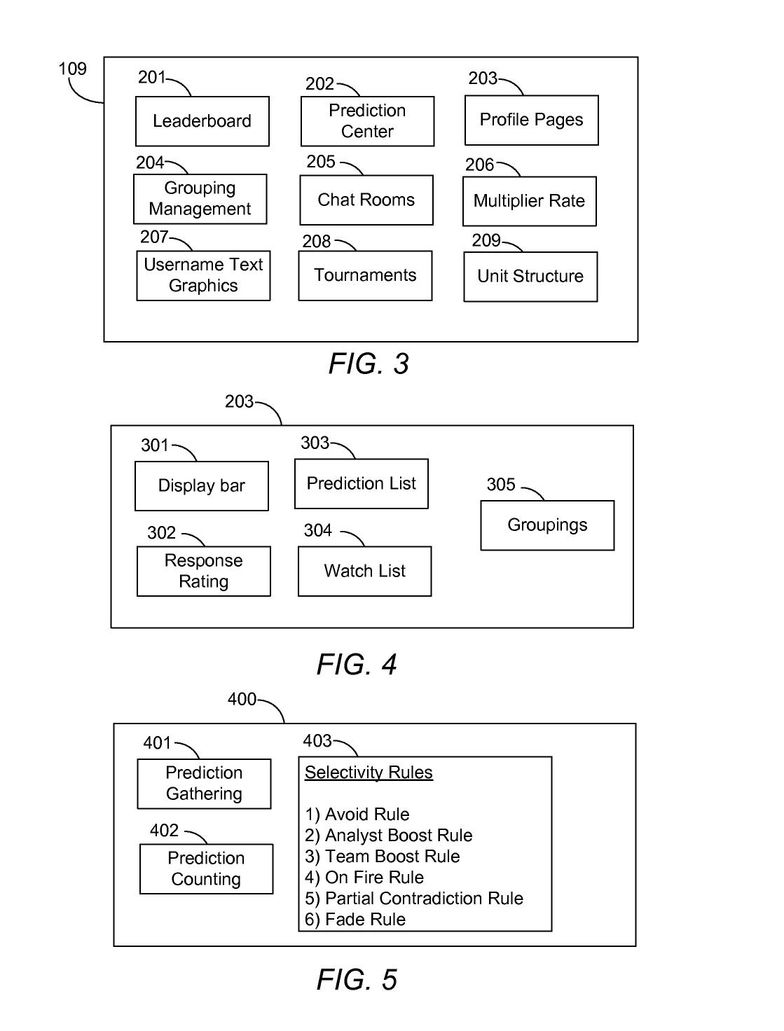

The database 16 provides persistent data storage (computer readable storage media, i.e. hardware) for system 101. Database 16 is in communication with control processor 14 and I/O interface 12. While the term “database” is primarily used, a memory or other suitable data storage arrangement may provide the functionality of the database 16. In alternative embodiments, the database 16 can be integral to or separate from the system 101 and can operate on one or more computers. The database 16 preferably provides non-volatile data storage for any information suitable to support the operation of the system 101, including various types of data discussed below in connection with FIGS. 3-5.

The maintenance interface 18 is configured to allow users to maintain desired operation of the system 101. In some embodiments, the maintenance interface 18 can be configured to allow for reviewing and/or revising the data stored in the database 16 and/or performing any suitable administrative tasks commonly associated with database management. This can include, for example, updating database management software, revising security settings, and/or performing data backup operations. In some embodiments, the maintenance interface 18 can be configured to allow for maintenance of the control processor 14 and/or the I/O interface 12. This can include, for example, software updates and/or administrative tasks such as security management and/or adjustment of certain tolerance settings.

The control processor 14 can be configured to perform a process or a plurality of processes such as the processes described below in connection with the associated Figures. Additionally, control processor 14 includes software programmed to compile prediction data of one or more analysts based upon an outcome and performance of the one or more analyst's selections. Processor 14 includes a non-transitory computer-readable medium with instructions stored thereon to execute predetermined steps. Analysts make selections regarding the future outcome of future events. The control processor 14 automatically tracks and records the performance history of the analysts. The performance history relates to the past accuracy in selecting the correct outcome for a selected number of past events. The control processor 14 automatically ranks the analysts according to performance history. There are a plurality of different types of events that may be addressed by the analyst. For example, sporting competition outcomes, stock performance, fantasy sports, and so forth. The control processor 14 ranks each analyst according to each category of events. The ranks are presented to the user through the display portal. The user is able to selectively view the analyst's prediction data (for future event) regarding a particular event by paying a fee. Because the analysts are ranked according to their performance history, the user is able to obtain a more qualified opinion more easily. The user is able to purchase a prediction from the analyst for a future event to improve their prediction performance and prediction accuracy.

Referring now also to FIG. 3 in the drawings, a series of features that may be displayed through the display portal associated with system 101 is illustrated. The software programmed into system 101 provides a plurality of features to a user. FIG. 3 illustrates the display portal 109 included within system 101. Leaderboard feature 201 shows the individual and/or groups that have the highest points. With respect to the sports markets, the leaderboard will show separate listings for the fantasy sports and for sports betting. In the investment markets, the leaderboard may show those brokers with the best performance for funds and/or stocks for example. The leaders on the leaderboard for any market is filterable by the user for a particular event. When using the term “event”, it is understood that such term may relate to a sport event or future performance of investments for a selected duration.

After creating an account, a user 103 can interact with the prediction center feature 202 of system 101. In the prediction center 202, users 103 make predictions on betting lines and fantasy-based sport scenarios. The betting lines may be related to any event. Each user 103 places confidence units on each prediction. The result of the user predictions will be calculated according to win/loss percentage and confidence units gained or lost. Then, results made within center 202 will determine where user 103 is ranked on leaderboard 201 and show on profile pages 203. Furthermore, decisions made within center 202 determine the win/loss ratio and units gained or lost for each user/player and grouping. Users 103 with the most confidence units accumulated for any specific category of events (best at predicting QBs, WRs, Teams, Players, Investments, etc.) will be represented and easily filtered to view on the appropriate leaderboard 201.

Referring now also to FIG. 4 in the drawings, a chart illustrating a more detailed view of the functions of profile pages 203 is shown. Profile pages 203 are separated into private pages and public pages. Each user 103 or grouping will have their own public and private profile page. The private profile page is only viewable by the owner of the profile (user). This page contains customization options that the profile owner can interact with to customize their private profile and public profile. For example, users 103 may have a display bar 301 that includes a username, bio about the user, selected specialties, and a website address. Additionally, the record and statistics of the user are viewable. Each user is able to provide feedback to an analyst regarding the quality of the predictions. This is captured in a response section 302. This represents an average of all ratings received from other users who have paid the particular user for their analysis and responses regarding predictions. The term analyst is used to denote a user whose record and ranking is of sufficient quality that their analysis and predictions are sought after and paid for by another user. Therefore, a user may also be an analyst if such user is paid for their analysis and predictions.

Other features in the private pages of pages 203 is a prediction list 303. User 103 is able to view his/her predictions and adjust the spread and units spent on each. Some of the features listed within the prediction list is a view of the outcome status of the competition (W/L/P), points spent, who a prediction was purchased from, and the date. This information is sortable for various different sports.

Private pages 203 also includes a watch list 304. Watch list 304 is sortable similarly to that of prediction list 303. The information displayed on list 304 is a number of analysts or groupings that are ranked highest for the particular category event or team or player selected. A user is able to sort the watch list information based on user performance or grouping performance over a particular time period. For example, a user 103 may sort by the amount of units gained over the last month, last week, or last season. The win/loss/push (W/L/P) records will be shown as well, but the units gained will determine the order in which the information is populated on the list. A user is able to view current predictions of the analyst/grouping by paying the fee.

User 103 is also able to view their groupings 305 within pages 203. Information, such as, sports type, grouping name, chat rooms, podcasts, and so forth associated with the grouping. Chatrooms 205 are available for analysts hired (paid for by user 103 to be in the grouping) by user 103 to have discussions. Users 103 who own the grouping may also invite other users/analysts to join them. Information made public to other users/analysts include the information located in display bar 301 and response rating 302.

Grouping management 204 is also included within system 101 to allow a user to more easily manage the grouping(s). Groups are composed of analysts from any number of leaderboards 201. Creators of the grouping “hire” analysts to be a part of the grouping. This means that the user pays a fee to retain the services of the analyst for a particular set amount of time. Creators of the grouping also apply rules and a unit structure 209 to the grouping. Rules help the software on processor 14 automatically compile and determine a single prediction from the plurality of predictions within the grouping. Unit structure 209 is used to determine how many confidence units the grouping uses for a particular prediction.

Display information similar to that in the public page of the user is displayed within the grouping management page 204. Here, individual members of the grouping are listed along with a location for private chat rooms, message boards, and podcasts. Use of the chat rooms, message boards, and podcasts may require further expense to the user to operate. The use of grouping management page 204 is designed to allow user 103 the necessary communication abilities to adequately run the grouping. The information on this page is private from view of the public.

As stated previously, a grouping is a collection of “hired” analysts by the user 103. The hiring occurs by the user paying a particular fee for the right to have access to the predictions of the analyst for a particular duration. The cost of the analyst within the grouping may increase or decrease during the predetermined time duration. User 103 may renew or rehire the analyst at the original price if the price has since increased or may pay a lower price if the price of the analyst at the time of renewal has decreased. Within a grouping, any particular analysts may be benched or taken out of a particular betting. Such may occur due to recent performance or expertise in a particular event is limited. In order to create a grouping, a user selects a team name and the type of category (i.e. sport) that the grouping will be focused in. Points may be purchased to allow the grouping to spend on bets.

Tournaments 208 may be entered into by groupings. Tournaments 208 can be based on different formats. Contestants compete by making predictions from within the prediction center on system 101 the same way they make predictions on their individual profile accounts. Users are able to choose to have the prediction submitted as a tournament prediction, their purchasable prediction, or both. The tournament formats are cross compatible between sports types and are also cross compatible between sports wagering and fantasy sports. Individual users and groupings compete for cash prizes and reputation boosting features. Participation in a tournament requires a fee.

Username text graphics 207 are changes in textual appearance based upon the recent performance of a user. For example, the text will change appearance on leaderboard 201 according to whether or not the user 103 is on a win streak or losing streak. Textual data within system 101 may be altered to convey relative recent performance. This can apply to user 103 and also analysts, other users, and groupings. Multiplier rate 206 is used to determine prediction cost for users and groupings to make predictions and hire analysts. The cost for an analyst can increase with the amount of “hires” it receives. Performance is also a factor. The multiplier rate reflects the user or group's team standing on leaderboard 201.

Referring now also to FIG. 5 in the drawings, a chart 400 of a series of processes or steps executed by the software and processor 14 of system 101 in order to formulate a single prediction from within a grouping is illustrated. Behind the scenes of the display portal and not viewable to user 103, system 101 includes a number of back end processes for processor 14 to execute in order to generate a prediction for a grouping. When dealing with individual analysts and the purchase of a single analyst's prediction or analysis, the process becomes relatively simple. A fee is paid and the information is provided to the user 103 to make an informed prediction. However, with groupings, processor 14 executes a series of functions to take the individual predictions of the members of the grouping and create a singular prediction for a particular future event.

System 101 automatically applies a series of prediction rules to one or more of the analysts in the grouping. A single prediction from the group of analysts is generated by the processor, wherein the processor programmed to gather all the predictions 401 from each analyst for each future event of interest to the user. This gathering occurs a predefined time prior to the occurrence of the event. The number of units applied to each analyst selection is made according to the unit structure 209. Each analyst makes a selection. Those selections made by the analysts of interest to the user 103 is processes. The predictions of the analysts are sorted according to the future event. This is done to allow a point value to be assigned to each future event representative of the probability of the future event occurring. For example, in a sports betting scenario, the games of interest are selected by user 103. The selections of the analysts are sorted according to the game. The predictions of each analyst is noted for each game and a summation of the predictions for the winner of each game is tallied or counted 402. If five (5) analysts vote for Chicago to beat Carolina and only one (1) analyst voted for Carolina to win, then the tally would be 5-1 in favor of Chicago. When sports games are not being betted on then a point value is assigned based on the belief that an occurrence or performance will happen (i.e. Yes it will or No it won't).

System 101 now applies user defined prediction rules and selectivity rules 403 to the assigned point values to generate a single prediction of the outcome of the future event (i.e. the game winner). Examples of selectivity rules 403 can be that only the top 3 teams are used for a particular event, or only top predictions of an analyst are counted, and so forth. System 101 is configured to permit a user 103 to apply restrictions or rules for how processor 14 and the software interpret and value each analyst's predictions. These rules may be modified by the user 103.

Exemplary selectivity rules are herein described. (1) Avoid Rule—system 101 is configured to automatically cancel or decrease confidence units by a particular amount when a certain prediction is determined (i.e. a particular team is selected to win); (2 & 3) Boost or Bench Rule—boosts the prediction count total for the prediction of a particular analyst in the grouping. This may also be applied to a grouping as a whole. Benching of team members is permitted. When an analyst in the group is benched, all of the predictions of that analyst are not factored into the prediction counting 402. This also nullifies all other enabled rules on that particular team member when benched. (4) On Fire Rule—when enabled, the system 101 will increase the prediction count by a predetermined amount when a particular analyst has attained a streak of wins of a predetermined number. Therefore, if analyst five selected Chicago to win, and such analyst was “on fire” then system 101 would add a point to the prediction count for that prediction to be tallied; (5) Partial Contradiction Rule—instead of completely canceling a generated group prediction if group members have opposite predictions, system 101 swill count how many group members are on each prediction, and generate a team prediction for the prediction with the most group members on it; and (6) Fade Rule—the prediction of an analyst will be input into system 101 as the opposite of what it given. This is useful when a user knows that an analyst has a high unsuccessful prediction accuracy history. This allows his cost to be cheap. The user then takes the position of always wanting to select the opposite of what the analyst chooses. The fade rule may be applied to a single analyst or the entire group. In an alternate embodiment, the fade rule may be applied only to the predictions made on the group member's worst team (W/L/P). A minimum setting of those teams/players/events that have had at least a selected number of predictions by the analyst may be appropriate and applied. Other group applied rules may also be used and selected by user 103 in order to obtain a singular prediction.

The system disclosed within the current application has many advantages over the prior art including at least the following: (1) ranking of analysts according to prediction history; (2) ability to purchase from analysts information related to the selection of a prediction; (3) formation of groups of analysts wherein the analysts provide predictions to a user; (4) software used by a processor to automatically generate a single prediction from a group of analysts; and (5) ability to compete groups against one another in a tournament setting.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

1. A system for compiling and comparing the prediction accuracy of one or more analysts to improve user prediction performance, the system comprising:
a processor having software programmed to compile prediction data of one or more analysts based upon an outcome and performance of the one or more analysts selections;
a database in communication with the processor and configured to provide persistent data storage; and
an input/output interface in communication with the processor and the database and configured to provide an interactive link between the user and the prediction data, the input/output interface providing a display portal defining a plurality of visually perceptible elements corresponding to the prediction data;
wherein the processor automatically tracks and records the performance history of the one or more analysts, the processor ranks the one or more analysts according to performance history, the processor presents the ranks of the one or more analysts to the user through the display portal, the user being able to purchase a prediction from any of the one or more analysts for a future event.

2. The system of claim 1, wherein the user is able to sort the ranks of the one or more analysts based upon the future event, the ranks being assigned to the one or more analysts based on performance data in selected categories of events.

3. The system of claim 1, wherein the processor is programmed to permit the user to see the prediction of a single analyst upon the payment of a fee.

4. The system of claim 1, wherein the software of the processor is programmed to generate a single prediction based upon the combined prediction of multiple analysts.

5. The system of claim 1, wherein the user is permitted to combine a number of analysts into a group for the generation of a single prediction.

6. The system of claim 5, wherein the user is required to pay a fee to each analyst in the group for access to each analysts' prediction.

7. The system of claim 5, wherein the user retains access to the analyst's future predictions for a predetermined time.

8. The system of claim 5, wherein the software automatically applies user defined prediction rules to one or more of the analyst predictions in the group.

9. The system of claim 5, wherein the single prediction from the group of analysts is generated by the processor, the processor programmed to:
gather all predictions from each analyst for each future event of interest to the user;
sort the predictions according to the future event;
assign a point value to each future event representative of the probability of the future event occurring;
apply user defined prediction rules to the assigned point values; and
generate a single prediction of the outcome of the future event.

10. The system of claim 1, wherein performance data of the user is stored and processed, such that the user is ranked with the one or more analysts.

11. The system of claim 10, wherein the user receives a fee for the sharing of the user's prediction of the future event.

12. A method of improving a prediction performance of a user, the method comprising:
recording, with a processor, the performance history of one or more analysts, the performance history related to the prediction accuracy made with respect to past events;
storing the rankings in a database in communication with the processor;
ranking, with the processor, each of the one or more analysts based upon prediction accuracy with respect to a category of events;
filtering the rankings according to a particular event category; and
permitting a user to sort through the rankings for a particular event category and allow the user to purchase a prediction of the one or more analysts for a future event;
wherein the prediction of the user is improved from the relative quality of the prediction of the ranked analyst.

13. The method of claim 12, wherein the processor is programmed to permit the user to see the prediction of a single analyst upon the payment of a fee.

14. The method of claim 12, further comprising:
generating a single prediction based upon the combined prediction of a plurality of analysts.

15. The method of claim 12, further comprising:
forming a group having a plurality of analysts, the user paying a fee for each analyst, the user receiving access to the predictions of the plurality of analysts.

16. The method of claim 15, wherein the processor automatically applies user defined prediction rules to the combined predictions of the one or more analysts in order to formulate a single prediction.

17. The method of claim 15, further comprising:
selling the single prediction of the group.

18. The method of claim 15, further comprising:
comparing the single prediction of the group with one or more alternate groups for monetary profit.

19. A non-transitory computer-readable medium with instructions stored thereon, that when executed by a processor, perform the steps comprising:
recording, with a processor, the performance history of one or more analysts, the performance history related to the prediction accuracy made with respect to past events;
storing the rankings in a database in communication with the processor;
ranking each the one or more analysts based upon prediction accuracy with respect to a category of events;
filtering the rankings according to a particular event category;
permitting a user to sort through the rankings for a particular event category and allow the user to purchase a prediction of the one or more analysts for a future event.

20. The non-transitory computer-readable medium of claim 19, further comprising:
combining the predictions from a plurality of analysts to generate a single prediction, the processor programmed to w/in the single prediction from the group of analysts is generated by the processor, the processor programmed to follow the steps of:
gathering all predictions from each analyst for a future event of interest to the user;
sorting the predictions according to the future event;
assigning a point value to the future event representative of the probability of the future event occurring; and
applying user defined prediction rules to the assigned point values.
